(19) United States
(12) Patent Application Publication
(10) Pub. No.: US 2026/0276409 A1
(43) Pub. Date: Sep. 17, 2026

(54) SCALE FACTOR ESTIMATION DEVICE, SCALE FACTOR ESTIMATION METHOD, AND STORAGE MEDIUM

(71) Applicants: DENSO CORPORATION, Kariya-city (JP); J-QuAD DYNAMICS Inc., Tokyo (JP)

(72) Inventor: Yuko KOKUBO, Tokyo (JP)

(21) Appl. No.: 19/564,916

(22) Filed: Mar. 12, 2026

(30) Foreign Application Priority Data
Mar. 17, 2025 (JP) 2025-042568

(51) Int. Cl. G01C 25/00; G01C 21/16

(52) U.S. Cl. CPC G01C 25/00; G01C 21/165

(57) ABSTRACT

A scale factor estimation device for estimating a scale factor, which is a correction value used when detecting a physical quantity representing a motion state of an own vehicle based on information output by a vehicle sensor mounted to the own vehicle. The scale factor estimation device includes: a first physical quantity acquisition unit configured to acquire a first physical quantity calculated based on the information output by the vehicle sensor, a second physical quantity acquisition unit configured to acquire a second physical quantity calculated based on satellite positioning information of the own vehicle, a reliability estimation unit configured to estimate the reliability of target data including the first physical quantity and the second physical quantity, and a scale factor calculation unit configured to accumulate data and calculate the scale factor based on the target data estimated as having a high reliability by the reliability estimation unit.

### CROSS-REFERENCE TO RELATED APPLICATIONS

The present application claims priority to Japanese Application No. 2025-42568, filed on Mar. 17, 2025. The contents of this application are incorporated herein by reference in their entirety.

### BACKGROUND

### 1. Technical Field

The present disclosure relates to a scale factor estimation device, a scale factor estimation method, and a storage medium. These estimate and correct a scale factor, which is a correction value used for detecting a physical quantity representing motion state of an own vehicle based on information output by a vehicle sensor mounted to the own vehicle.

### 2. Related Art

Conventionally, techniques to calculate or correct scale factors with high precision to achieve highly reliable detection have been proposed. For example, JP2023149060A discloses a technique of a scale factor estimation device for correcting the scale factor used in an inertial measurement unit. Specifically, the scale factor estimation device described in JP2023149060A includes an inertial azimuth change amount calculation unit, a satellite positioning azimuth change amount calculation unit, and a scale factor estimation unit.

The inertial azimuth change amount calculation unit calculates azimuth change amount in yaw direction of a vehicle body based on information output by the inertial measurement device mounted to the vehicle body. The satellite positioning azimuth change amount calculation unit calculates the azimuth change amount in the yaw direction of the vehicle body from differential information between information output by a first antenna and a second antenna, each capable of acquiring positioning information from satellites, which are installed at a predetermined distance or more apart from the vehicle body.

The scale factor estimation unit estimates the scale factor of the inertial measurement device by referencing the azimuth change amount calculated by the satellite positioning azimuth change amount calculation unit against the azimuth change amount calculated by the inertial azimuth change amount calculation unit. The scale factor estimation unit corrects the output of the inertial measurement device based on the estimated scale factor.

### SUMMARY

In this type of scale factor estimation technology, further improvement in calculation accuracy is being pursued. This disclosure aims to accomplish the improvement.

According to one aspect of the present disclosure, a scale factor estimation device (6) for estimating a scale factor is provided. The scale factor is a correction value used when detecting a physical quantity representing a motion state of an own vehicle based on information output by a vehicle sensor (3) mounted to the own vehicle. The scale factor estimation device comprises: a first physical quantity acquisition unit (601) configured to acquire a first physical quantity calculated based on the information output by the vehicle sensor, a second physical quantity acquisition unit (602) configured to acquire a second physical quantity calculated based on satellite positioning information of the own vehicle, a reliability estimation unit (603) configured to estimate the reliability of target data including the first physical quantity and the second physical quantity, and a scale factor calculation unit (604) configured to accumulate data and calculate the scale factor based on the target data estimated as having a high reliability by the reliability estimation unit.

According to another aspect of the present disclosure, a scale factor estimation method for estimating a scale factor is provided. The scale factor is a correction value used when detecting a physical quantity representing a motion state of an own vehicle based on information output by a vehicle sensor (3) mounted to the own vehicle. The scale factor estimation method comprises: acquiring a first physical quantity calculated based on the information output by the vehicle sensor, acquiring a second physical quantity calculated based on satellite positioning information of the own vehicle, estimating the reliability of target data including the first physical quantity and the second physical quantity, and accumulating data and calculating the scale factor based on the target data estimated as having a high reliability by the reliability estimation unit.

According to another aspect of the present disclosure, a non-transitory computer-readable storage medium storing a scale factor estimation program for estimating a scale factor is provided. The scale factor is a correction value used when detecting a physical quantity representing a motion state of an own vehicle based on information output by a vehicle sensor (3) mounted to the own vehicle. The scale factor estimation program causing a processor to perform: acquiring a first physical quantity calculated based on the information output by the vehicle sensor, acquiring a second physical quantity calculated based on satellite positioning information of the own vehicle, estimating the reliability of target data including the first physical quantity and the second physical quantity, and accumulating data and calculating the scale factor based on the target data estimated as having a high reliability by the reliability estimation unit.

In the various sections of the application documents, reference symbols in parentheses may be assigned to various elements. However, such reference symbols merely indicate one example of the correspondence between the element and the specific means described in the embodiments described later. Therefore, the present disclosure is not limited by the above reference symbols.

### BRIEF DESCRIPTION OF THE DRAWING

FIG. 1 is a block diagram showing an example configuration of a system to which a vehicle speed estimation device is applied.

FIG. 2 is a block diagram showing an example of functional configuration of the vehicle speed estimation device.

FIG. 3 is a flowchart showing an example of processing of the vehicle speed estimation device shown in FIG. 2.

FIG. 4 is a graph showing an example of the processing of the vehicle speed estimation device shown in FIG. 2.

FIG. 5 is a flowchart showing an example of processing of the vehicle speed estimation device shown in FIG. 2.

### DETAILED DESCRIPTION OF THE PREFERRED EMBODIMENTS

### (Embodiment)

The following describes exemplary embodiments or specific examples of the present disclosure, referring to the drawings as appropriate. The descriptions of the following embodiments, modifications thereof, and the related drawings are simplified or shown in schematic form to concisely explain the content of the present disclosure and do not limit the scope of the disclosure. Therefore, it goes without saying that the descriptions in the drawings and the specific device configurations actually manufactured and sold may not necessarily match. That is, unless the applicant explicitly limits the scope of the present application through the application process, the present disclosure should not be interpreted restrictively based solely on the descriptions in the drawings or the corresponding descriptions of device configurations, functions, or operations explained below.

### (System Configuration)

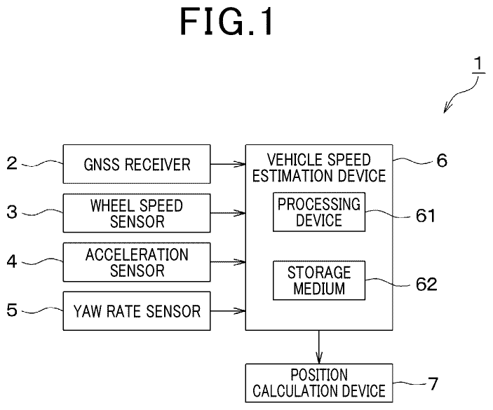

First, referring to FIG. 1, system 1 is applied to vehicles traveling on roads and may be used, for example, as a map system for autonomous navigation. Such a map system includes functions for map generation, map updating, and map utilization.

Specifically, in this embodiment, the system 1 comprises a GNSS receiver 2, a wheel speed sensor 3, an acceleration sensor 4, a yaw rate sensor 5, a vehicle speed estimation device 6, and a position calculation device 7. GNSS stands for Global Navigation Satellite System. These components are mounted to a vehicle. Hereinafter, this vehicle is referred to as the “own vehicle.”

The GNSS receiver 2 receives signals from positioning satellites. The GNSS receiver 2 is connected to the vehicle speed estimation device 6 via vehicle network and communicates with the vehicle speed estimation device 6. The GNSS receiver 2 transmits information based on the received signals to the vehicle speed estimation device 6.

The wheel speed sensor 3 detects the number of pulses per unit time, the pulses being generated by the rotation of wheels of the own vehicle. The wheel speed sensor 3 is connected to vehicle speed estimation device 6 via the vehicle network and communicates with the vehicle speed estimation device 6. The wheel speed sensor 3transmits the detected pulse count to the vehicle speed estimation device 6.

The acceleration sensor 4 detects acceleration acting on the own vehicle (i.e., longitudinal acceleration). The acceleration sensor 4 is connected to the vehicle speed estimation device 6 via the vehicle network and communicates with vehicle speed estimation device 6. The acceleration sensor 4 transmits the detected acceleration to the vehicle speed estimation device 6.

The yaw rate sensor 5 detects yaw rate (i.e., rotational angular velocity) of the own vehicle. The yaw rate sensor 5 is connected to the vehicle speed estimation device 6 via the vehicle network and communicates with vehicle speed estimation device 6. The yaw rate sensor 5 transmits the detected yaw rate to the vehicle speed estimation device 6.

The vehicle speed estimation device 6 estimates vehicle speed, i.e., the travelling speed of the own vehicle. The vehicle speed estimation device 6 may be a so-called ECU. The vehicle speed estimation device 6 may estimate the vehicle speed based on inputs from the GNS receiver 2 and the onboard sensors including the wheel speed sensor 3, the acceleration sensor 4, and the yaw rate sensor 5. ECU stands for Electronic Control Unit.

In this embodiment, the vehicle speed estimation device 6 has a configuration as a so-called vehicle computer, comprising at least a processing device 61 and a storage medium 62. The processing device 61 includes at least one CPU and/or MPU. CPU stands for Central Processing Unit. MPU stands for Micro Processor Unit.

The storage medium 62 includes at least one non-transitory physical storage medium, such as ROM or non-volatile rewritable memory. ROM stands for Read Only Memory. The non-volatile rewritable memory is a storage device that allows information to be rewritten while power is applied and retains information in a state where it cannot be rewritten during power shutdown. The non-volatile rewritable memory may be, for example, flash ROM or magnetic recording devices.

The storage medium 62 stores a computer program and various data such as initial values, maps, and lookup tables necessary for executing the computer program. The vehicle speed estimation device 6 is configured to perform vehicle speed estimation processing by the processing unit 61 reading and executing the vehicle speed estimation program stored in the storage medium 62. Details regarding the functions of the vehicle speed estimation device 6 and the vehicle speed estimation operations performed thereby will be described later.

The position calculation device 7 calculates a position of the own vehicle based on the vehicle speed of the own vehicle estimated by vehicle speed estimation device 6. The position calculation device 7 also has a configuration as a so-called on-board computer, like the vehicle speed estimation device 6.

### (Vehicle Speed Estimation Device)

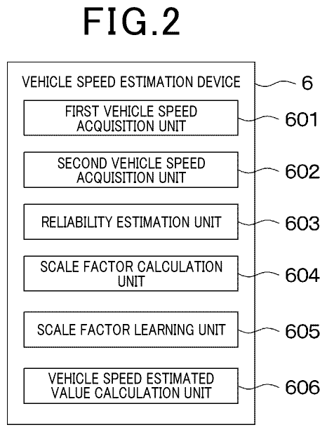

FIG. 2 is a block diagram showing an example of functional configuration of the vehicle speed estimation device 6. The functional configuration of the vehicle speed estimation device 6 is realized by the processing unit 61 provided in the vehicle speed estimation device 6 reading and executing the vehicle speed estimation program from storage medium 62. The following describes an overview of the functional configuration of the vehicle speed estimation device 6 according to this embodiment, referring to FIGS. 1 and 2.

As shown in FIG. 2, the vehicle speed estimation device 6 comprises a first vehicle speed acquisition unit 601, a second vehicle speed acquisition unit 602, a reliability estimation unit 603, a scale factor calculation unit 604, a scale factor learning unit 605, and a vehicle speed estimated value calculation unit 606. These functional configurations are provided for convenience in explaining the functions performed by the vehicle speed estimation device 6 and do not imply that corresponding software routines or hardware units exist separately and independently.

The first vehicle speed acquisition unit 601, which is an example of a “first physical quantity acquisition unit”, acquires a first vehicle speed of the own vehicle, which is a physical quantity calculated based on the output information by wheel speed sensor 3. In this embodiment, the first vehicle speed acquisition unit 601 calculates the first vehicle speed, an example of a “first physical quantity”, based on the number of pulses received from the wheel speed sensor 3. Since the method for calculating vehicle speed based on the information output by the wheel speed sensor 3 is already known technology at the time of filing this application, further details are omitted.

The second vehicle speed acquisition unit 602, which is an example of a “second physical quantity acquisition unit”, acquires a second vehicle speed calculated based on the satellite positioning information of the own vehicle. In this embodiment, the second vehicle speed acquisition unit 602 calculates the second vehicle speed, an example of a “second physical quantity”, based on signals from positioning satellites received by the GNSS receiver 2. Since the method for calculating vehicle speed based on satellite positioning information is already known or well-known technology at the time of filing this application, further details are omitted.

The reliability estimation unit 603 evaluates reliability of target data. The reliability of the target data is used by scale factor calculation unit 604 for calculating the scale factor. The scale factor in this embodiment is a correction value used when detecting the vehicle speed based on the information output by the wheel speed sensor 3. The target data includes a first vehicle speed and a second vehicle speed. The target data may include data for the first vehicle speed and the second vehicle speed acquired at a certain point in time. The target data may also include data of acceleration and/or yaw rate in addition to the first vehicle speed and the second vehicle speed.

More specifically, the reliability estimation unit 603 determines whether the target data satisfies a predetermined reliability condition and evaluates target data determined to satisfy the predetermined reliability condition as the target data having high reliability. The reliability estimation unit 603 accumulates the target data evaluated as having high reliability as data for calculation. As detailed examples will be described later, the reliability condition may be conditions regarding the value of the first vehicle speed, the value of the second vehicle speed, the relationship between the first and second vehicle speeds, acceleration, yaw rate, etc.

The scale factor calculation unit 604 calculates the scale factor based on, for example, ratio of the first vehicle speed and the second vehicle speed and relationship between the ration and the first vehicle speed. Since the scale factor for vehicle speed estimation is already known or well-known technology at the time of filing this application, further details regarding this are omitted.

In this embodiment, scale factor calculation unit 604 calculates the scale factor based on the target data determined to be having high by the reliability estimation unit 603 as it satisfied the predetermined reliability conditions. For example, the scale factor calculation unit 604 may calculate the scale factor based on the accumulated data for calculation, and a known method such as the least squares method.

The scale factor learning unit 605 performs learning process for the scale factor. The learning process for the scale factor involves repeatedly accumulating data and calculating the scale factor until the calculation accuracy of the scale factor by scale factor calculation unit 604 reaches a predetermined target accuracy.

For example, the scale factor learning unit 605 does not decide whether to complete the learning process until amount of the target data reaches the predetermined amount. When the amount of the target data reaches the predetermined amount, the scale factor learning unit 605 may decide whether to complete the learning process based on the fluctuation state of the calculated scale factor values. The fluctuation state may be information indicating result of comparing statistical values, such as the variance or standard deviation of the difference between the first vehicle speed and the second vehicle speed, with a predetermined threshold. Alternatively, it may be a difference between the maximum value and the minimum value of the difference between the first vehicle speed and the second vehicle speed within a predetermined period extending back a predetermined amount of time from the current point in time.

The vehicle speed estimated value calculation unit 606 calculates an estimated value of the vehicle speed based on results of scale factor calculation process and learning process. For example, the vehicle speed estimated value calculation unit 606 may use the more accurate one of the previously obtained learning value, obtained upon completion of the learning process by the scale factor learning unit 605, and the current value calculated this time by the scale factor calculation unit 604, as the scale factor for calculating the current vehicle speed.

### (Operation Overview)

The following describes an overview of the operation of the device configuration according to this embodiment, namely, an overview of the execution of the method and program according to this embodiment. In the following description, the configuration possessed by the vehicle speed estimation device 6 according to this embodiment and the method and program executed thereby may be collectively referred to as “the present embodiment”.

In this embodiment, the GNSS receiver 2 acquires the satellite positioning information for the own vehicle and inputs it to the vehicle speed estimation device 6. The wheel speed sensor 3 detects the wheel speed of the own vehicle and inputs it to the vehicle speed estimation device 6. The acceleration sensor 4 detects the acceleration acting on the own vehicle and inputs it to the vehicle speed estimation device 6. The yaw rate sensor 5 detects the yaw rate of the own vehicle and inputs it to the vehicle speed estimation device 6. The vehicle speed estimation device 6 estimates the vehicle speed based on these input data.

Specifically, the first vehicle speed acquisition unit 601 acquires, or calculates, sensor vehicle speed, which is the first vehicle speed, based on the wheel speed detected by the wheel speed sensor 3. The second vehicle speed acquisition unit 602 acquires, or calculates, GNSS vehicle speed, which is the second vehicle speed, based on satellite positioning information. The reliability estimation unit 603 evaluates the reliability of the target data, which includes the sensor vehicle speed and the GNSS vehicle speed. Hereinafter, the target data may include the calculated value of the sensor vehicle speed for this instance, the calculated value of the GNSS vehicle speed for this instance, and the values of acceleration and/or yaw rate at the time of these calculations, i.e., the current time.

Specifically, for example, the reliability estimation unit 603 evaluates the target data satisfying some or all of the following reliability conditions as the target data having high reliability and accumulates such target data as the data for calculation. Some of these conditions may be omitted.
The speed is equal to or greater than a threshold speed (e.g., 1 km/h)
The variance of the difference between the sensor vehicle speed and the GNSS vehicle speed is below a threshold
The yaw rate is below a threshold
The yaw rate accuracy is better than a threshold
The acceleration is below a threshold
The acceleration difference is below a threshold

The scale factor calculation unit 604 calculates the scale factor based on the target data determined to be having high reliability by the estimation unit 603. The scale factor learning unit 605 performs the learning processing for the scale factor so that the calculation accuracy of the scale factor by the scale factor calculation unit 604 reaches a predetermined target accuracy. The vehicle speed estimated value calculation unit 606 calculates the estimated value of the vehicle speed based on the results of the scale factor calculation and learning.

### (Operation Example)

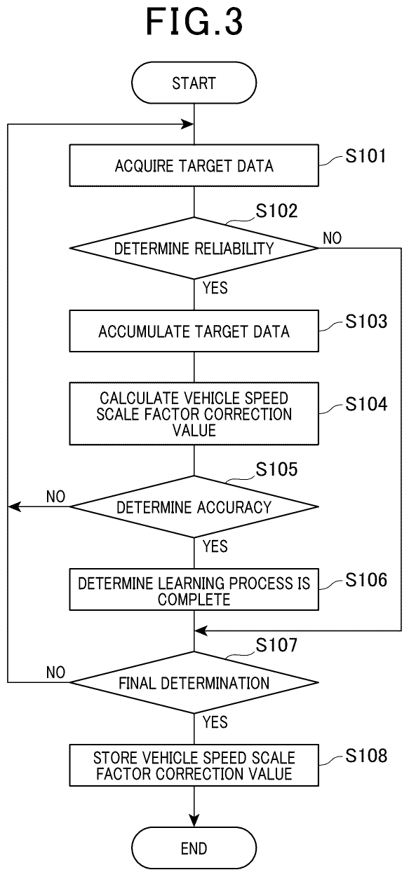

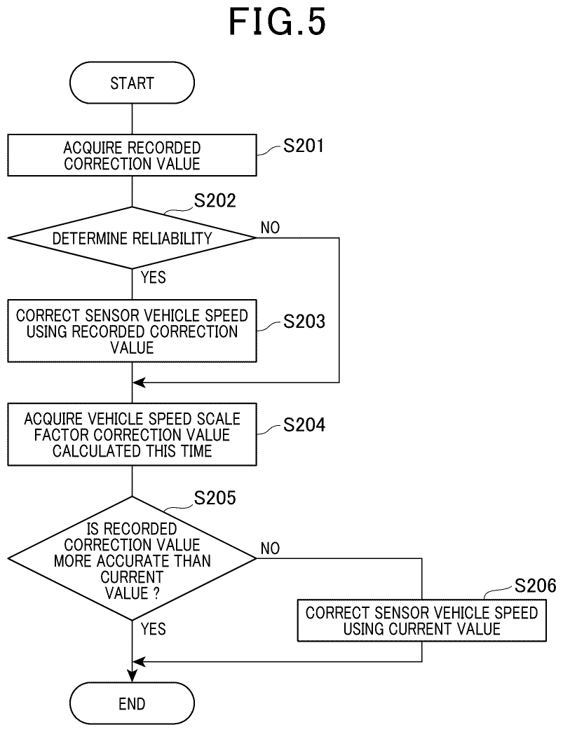

FIG. 3 shows a flowchart showing the process corresponding to the scale factor estimation program included in the vehicle speed estimation program of this embodiment. In the flowchart of FIG. 3, “S” stands for “step”. The same applies to the flowchart of FIG. 5 described later. Using these flowcharts, a specific example of the scale factor estimation operation of this embodiment is described below.

The processing unit 61 of the vehicle speed estimation device 6 performs the scale factor estimation method according to this embodiment by reading the program according to this embodiment from the storage medium 62 and executing it at predetermined time intervals (e.g., 100 msec). When the program is started to be executed, the processing unit 61 first performs the scale factor calculation routine shown in FIG. 3.

In the scale factor calculation process, the processing unit 61 first sequentially executes the processing of steps 101 and 102. In step 101 the processing unit 61 acquires the target data. In step 102, the processing unit 61 determines whether the target data acquired in step 101 satisfies the reliability condition. In a case that the target data satisfies the reliability condition (step 102=YES), the processing unit 61 sequentially performs the processing of steps 103 to 105.

In step 103, the processing unit 61 stores the target data determined in step 102 to satisfy the reliability condition as the data for calculation. In step 104, the processing unit 61 calculates a correction value for the scale factor (hereinafter referred to as a “vehicle speed scale factor correction value”) based on the stored data for calculation.

In step 105, the processing unit 61 determines the calculation accuracy of the scale factor. Specifically, the processing unit 61 determines whether a predetermined accuracy determination condition is satisfied. The accuracy determination condition may include, for example, the calculated accuracy reaches a target accuracy. The accuracy determination condition may also include, for example, the amount of the target data reaches a predetermined number.

In a case that the accuracy determination condition is satisfied (step 105=YES), the processing unit 61 advances the processing to steps 106 and 107. On the other hand, in a case that the accuracy determination condition is not satisfied (step 105=NO), the processing unit 61 returns the processing to step 101.

In step 106, the processing unit 61 determines that the learning process is complete. Specifically, the processing unit 61 sets the learning completion flag (i.e., learning completion flag=1). After processing step 106, the processing unit 61 proceeds to step 107. In addition, in a case that the target data does not satisfy the reliability condition (step 102=NO), the processing unit 61 skips processing steps 103 to 106 and proceeds to step 107.

In step 107, the processing unit 61 determines whether the final determination condition is satisfied. The final determination condition includes, for example, the learning completion flag is set, the correction value is a late-stage value calculated by accumulating and learning from a large amount of data during that trip, and a predetermined calculation accuracy has been reached to a degree deemed appropriate for use as an initial value or a confirmed correction value in the next trip.

In a case that the final determination condition is not satisfied (step 107=NO), the processing unit 61 returns the processing to step 101. On the other hand, in a case that the final determination condition is satisfied (step 107=YES), the processing unit 61 performs the processing of step 108 and then terminates this routine. In step 108, the processing unit 61 stores the vehicle speed scale factor correction value calculated this time as a confirmed correction value.

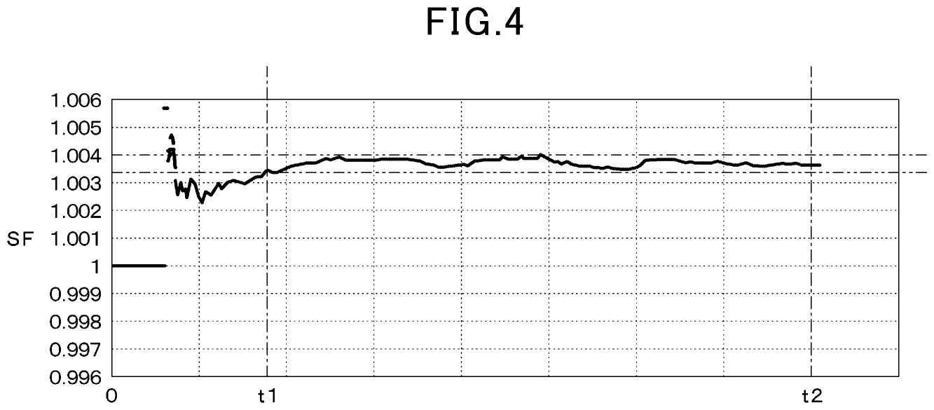

FIG. 4 illustrates how the vehicle speed scale factor correction value converges through the learning process. In the graph of FIG. 4, the vertical axis SF indicates the vehicle speed scale factor correction value, and the horizontal axis indicates time. At the start of the learning process, the value fluctuates significantly from the pre-learning default value of 1. However, after some time passes, the value begins to converge. Time t1 corresponds to the point at which learning completion is determined. Subsequently, while fluctuating slightly within a predetermined range, the value converges to a nearly constant value around time t2. This time t2 corresponds to the point at which the final determination condition is satisfied.

FIG. 5 shows a vehicle speed calculation value correction process using the calculated vehicle speed scale factor correction value, included in the vehicle speed estimation program according to this embodiment. In this process, the processing unit 61 first sequentially performs the processing of steps 201 and 202.

In step 201, the processing unit 61 acquires the recorded correction value, i.e., the stored confirmed correction value. In step 202, the processing unit 61 estimates the reliability of the recorded correction value acquired in step 201. For example, the processing unit 61 estimates the reliability of the recorded correction value as high when the recorded correction value falls within a predetermined range (the record correction value satisfies a predetermined reliability condition).

In a case that the record correction value satisfies the predetermined reliability condition (step 202=YES), the processing unit 61 sequentially performs the processing of steps 203 and 204. On the other hand, in a case that the reliability of the record correction value does not satisfy the predetermined reliability condition (step 202=NO), the processing unit 61 skips the processing of step 203 and proceeds to step 204.

In step 203, the processing unit 61 corrects the sensor vehicle speed using the recorded correction value. In step 204, the processing unit 61 acquires the vehicle speed scale factor correction value calculated this time in the process of FIG. 3 being performed parallelly. The value acquired in step 204 is referred to as a “current value”. After the processing in step 204, the processing unit 61 proceeds to step 205.

In step 205, the processing unit 61 performs an accuracy comparison between the recorded correction value and the current value. In a case that the current value is more accurate than the recorded correction value (step 205=NO), the processing unit 61 performs the processing in step 206 and then terminates this routine. In step 206, the processing unit 61 corrects the sensor vehicle speed using the current value instead of the recorded correction value. On the other hand, in a case that the recorded correction value is more accurate than the current value (step 205=YES), the processing unit 61 skips the processing in step 206 and terminates this routine.

### (Effect)

In conventional techniques of this type, when the correction value estimated through real-time correction, etc., fluctuates, jitter or distortion in the processing results partially occurs at the points where the correction value changes. In this case, it becomes unsuitable for application to a map system. Furthermore, accuracy is poor unless a large amount of data is accumulated and referenced. Additionally, sections with poor accuracy may occur depending on conditions such as the driving location and environment. In contrast, this embodiment estimates correction values by accumulating highly reliable data. It also references more data, stores the calculated final result, and enables stable correction.

Specifically, this embodiment estimates the reliability of target data, accumulates data with high accuracy, calculates and updates vehicle speed correction values from the accumulated target data. Then, when a certain level of accuracy is maintained for the correction values and the accuracy estimation is valid, learning is completed. Furthermore, accumulation and updating continue, and the final estimated value is stored as a confirmed correction value. Using this confirmed correction value, consistent correction is applied during the next drive.

As described above, according to this embodiment, it is possible to further enhance the accuracy of calculating or estimating the scale factor for vehicle speed correction compared to conventional techniques.

### MODIFIED EXAMPLES

The present disclosure is not limited to the above embodiments or specific examples. Therefore, appropriate modifications may be made to the above embodiments, etc. Representative modified examples are described below. In the following description of the modified examples, the differences from the above embodiments are primarily explained. Furthermore, identical or equivalent parts between the above embodiments and the following modified examples are denoted by the same reference symbols. Therefore, in the description of the following modified examples, the description in the above embodiments may be appropriately incorporated by reference for components having the same reference symbols, unless there is a technical contradiction or a need for special additional explanation.

The present disclosure is not limited to the specific applications or device configurations shown in the above embodiments. For example, the own vehicle may be a so-called ordinary automobile, a large vehicle, or even a two-wheeled or three-wheeled vehicle. That is, there are no particular limitations on the type, shape, or size of the vehicle body. The same applies to the other vehicle Vt.

The vehicle speed estimation device 6 may be an ECU for controlling the operation of the own vehicle. The ECU may be referred to as a driving control ECU, but it may also be a driving assistance ECU or an autonomous driving ECU. The driving assistance ECU is configured to achieve Level 1 or Level 2 driving automation as defined in the SAE International standard “SAE J3016”. The autonomous driving ECU is configured to achieve any of Levels 3 to 5 driving automation as defined in the same standard. That is, the system 1 may be either a driving assistance system or an autonomous driving system.

All or part of the vehicle speed estimation device 6 may be configured with digital circuits, such as ASICs or FPGAs, capable of realizing the above functions or operations. ASIC stands for Application Specific Integrated Circuit. FPGA stands for Field Programmable Gate Array. That is, within vehicle speed estimation device 6, the in-vehicle microcomputer portion and the digital circuit portion may coexist.

The computer program according to the present disclosure, enabling the various operations, procedures, or processes described in the above embodiments, may be downloaded or upgraded to non-volatile rewritable memory via V2X communication using a communication device. V2X stands for Vehicle to X. Alternatively, such a computer program may be downloaded or upgraded via terminal equipment installed at the vehicle's manufacturing plant, maintenance facility, dealership, etc. The non-volatile rewritable memory storing such a computer program is not limited to semiconductor memory such as flash memory but may also be an optical or magnetic recording medium, etc.

Thus, the above functional components and processes may be implemented by a dedicated computer provided by configuring a processor and memory programmed to execute one or more functions embodied by a computer program. Alternatively, the above functional configurations and processing may be implemented by a dedicated computer provided by configuring a processor using one or more dedicated hardware logic circuits. Alternatively, the above functional configurations and processing may be implemented by one or more dedicated computers configured by a combination of one or more processors programmed to execute one or more functions, one or more units of memory, and one or more hardware logic circuits with one or more other processors.

The computer program may be stored as instructions executable by a computer on a computer-readable non-transitory physical storage medium. Each of the above functional configurations and processes may also be expressed as a computer program containing procedures to implement them, or as a non-transitory physical storage medium storing said computer program.

The present disclosure is not limited to the specific functions or modes of operation shown in the above embodiments. For example, an upper limit may be set on the number of target data points stored due to data capacity constraints. Weighting processing, etc., may be performed as appropriate during the calculation of correction values or learning. In the above embodiment, the reliability estimation unit 603 performs both data reliability determination and accumulation of data satisfying reliability conditions. However, these functions may be performed by separate functional blocks. The vehicle speed estimation device 6 may further include a data accumulation unit, in addition to reliability estimation unit 603, for accumulating data satisfying reliability conditions. The scale factor calculation unit 604 may also include a data storage function. In this case, scale factor calculation unit 604 may calculate the scale factor based on the data for calculation stored when deemed reliable by reliability estimation unit 603.

The scope of application of the present disclosure is not limited to vehicle speed estimation. That is, the “physical quantity” related to the present disclosure is not limited to vehicle speed. Therefore, the present disclosure may also be applied, for example, to techniques for calculating or estimating scale factors for correcting gyro outputs.

It goes without saying that the elements constituting the above embodiments are not necessarily essential, except where explicitly stated as essential or where they are clearly essential by principle. Furthermore, when numerical values such as the number, quantity, amount, or range of components are mentioned, the present disclosure is not limited to those specific numbers, except where explicitly stated as essential or where they are clearly limited to specific numbers by principle. Similarly, when the shape, direction, positional relationship, etc., of components is mentioned, unless explicitly stated as essential or unless it is inherently limited to a specific shape, direction, positional relationship, etc., the present disclosure is not limited to that shape, direction, positional relationship, etc.

Similar expressions such as “acquire”, “calculate”, “estimate”, and “detect” are interchangeable within the scope of technical non-contradiction. Furthermore, “exceeding the threshold” and “equal to or greater than the threshold” are interchangeable within the scope of technical non-contradiction. The same applies to “below the threshold” and “equal to or less than the threshold”.

The modified examples are also not limited to the above illustrations. For example, all or part of one modified example may be combined with all or part of another modified example, provided there is no technical contradiction. Furthermore, all or part of the above specific examples may be combined with all or part of the above modified examples, provided there is no technical contradiction.

### (Disclosure Perspective)

As is evident from the description of the configurations and operations of the embodiments and variations described above, the present disclosure includes at least the following aspects.

### [Aspect 1-1]

A scale factor estimation device (6) for estimating a scale factor, which is a correction value used when detecting a physical quantity representing a motion state of an own vehicle based on information output by a vehicle sensor (3) mounted to the own vehicle, the scale factor estimation device comprising:
a first physical quantity acquisition unit (601) configured to acquire a first physical quantity calculated based on the information output by the vehicle sensor;
a second physical quantity acquisition unit (602) configured to acquire a second physical quantity calculated based on satellite positioning information of the own vehicle;
a reliability estimation unit (603) configured to estimate the reliability of target data including the first physical quantity and the second physical quantity; and
a scale factor calculation unit (604) configured to accumulate data and calculate the scale factor based on the target data estimated as having a high reliability by the reliability estimation unit.

### [Aspect 1-2]

The scale factor estimation device according to Aspect 1-1, further comprising a scale factor learning unit (605) configured to accumulate calculation results of the scale factor and performs a learning process for the scale factor so that a calculation accuracy of the scale factor reaches a predetermined target accuracy.

### [Aspect 1-3]

The scale factor estimation device according to Aspect 1-2, wherein the scale factor learning unit is configured to determine whether to complete the learning process based on the fluctuation state of the calculated value of the scale factor.

### [Aspect 1-4]

The scale factor estimation device according to Aspects 1-2 or 1-3, configured to select one information that has higher calculation accuracy from the learned value already obtained by completion of the learning process and a current value calculated this time by the scale factor calculation unit, as the scale factor for calculating the physical quantity.

### [Aspect 2-1]

A scale factor estimation method for estimating a scale factor, which is a correction value used when detecting a physical quantity representing a motion state of an own vehicle based on information output by a vehicle sensor (3) mounted to the own vehicle, the scale factor estimation method comprising:
acquiring a first physical quantity calculated based on the information output by the vehicle sensor;
acquiring a second physical quantity calculated based on satellite positioning information of the own vehicle;
estimating the reliability of target data including the first physical quantity and the second physical quantity; and
accumulating data and calculating the scale factor based on the target data estimated as having a high reliability by the reliability estimation unit.

### [Aspect 2-2]

The scale factor estimation method according to Aspect 2-1, further comprising: accumulating calculation results of the scale factor and performs a learning process for the scale factor so that a calculation accuracy of the scale factor reaches a predetermined target accuracy.

### [Aspect 2-3]

The scale factor estimation method according to Aspect 2-2, wherein the learning process includes determining whether to complete the learning process based on the fluctuation state of the calculated value of the scale factor.

### [Aspect 2-4]

The scale factor estimation method according to Aspects 2-2 or 2-3, further comprising selecting one information that has higher calculation accuracy from the learned value already obtained by completion of the learning process and a current value calculated this time by the scale factor calculation unit, as the scale factor for calculating the physical quantity.

### [Aspect 3-1]

A scale factor estimation program for estimating a scale factor, which is a correction value used when detecting a physical quantity representing a motion state of an own vehicle based on information output by a vehicle sensor (3) mounted to the own vehicle, the scale factor estimation program causing a processor to perform:
acquiring a first physical quantity calculated based on the information output by the vehicle sensor;
acquiring a second physical quantity calculated based on satellite positioning information of the own vehicle;
estimating the reliability of target data including the first physical quantity and the second physical quantity; and
accumulating data and calculating the scale factor based on the target data estimated as having a high reliability by the reliability estimation unit.

### [Aspect 3-2]

The scale factor estimation program according to Aspect 3-1, the scale factor estimation program further causes the processor to perform: accumulating calculation results of the scale factor and performs a learning process for the scale factor so that a calculation accuracy of the scale factor reaches a predetermined target accuracy.

### [Aspect 3-3]

The scale factor estimation program according to Aspect 3-2, wherein the learning process includes determining whether to complete the learning process based on the fluctuation state of the calculated value of the scale factor.

### [Aspect 3-4]

The scale factor estimation program according to Aspects 3-2 or 3-3, the scale factor estimation program further causes the processor to perform: selecting one information that has higher calculation accuracy from the learned value already obtained by completion of the learning process and a current value calculated this time by the scale factor calculation unit, as the scale factor for calculating the physical quantity.

### [Aspect 4-1]

A non-transitory computer-readable storage medium storing a scale factor estimation program for estimating a scale factor, which is a correction value used when detecting a physical quantity representing a motion state of an own vehicle based on information output by a vehicle sensor (3) mounted to the own vehicle, the scale factor estimation program causing a processor to perform:
acquiring a first physical quantity calculated based on the information output by the vehicle sensor;
acquiring a second physical quantity calculated based on satellite positioning information of the own vehicle;
estimating the reliability of target data including the first physical quantity and the second physical quantity; and
accumulating data and calculating the scale factor based on the target data estimated as having a high reliability by the reliability estimation unit.

### [Aspect 4-2]

The storage medium according to Aspect 4-1, the scale factor estimation program further causes the processor to perform: accumulating calculation results of the scale factor and performs a learning process for the scale factor so that a calculation accuracy of the scale factor reaches a predetermined target accuracy.

### [Aspect 4-3]

The storage medium according to Aspect 4-2, wherein the learning process includes determining whether to complete the learning process based on the fluctuation state of the calculated value of the scale factor.

### [Aspect 4-4]

The storage medium according to Aspects 4-2 or 4-3, the scale factor estimation program further causes the processor to perform: selecting one information that has higher calculation accuracy from the learned value already obtained by completion of the learning process and a current value calculated this time by the scale factor calculation unit, as the scale factor for calculating the physical quantity.

What is claimed is:

1. A scale factor estimation device for estimating a scale factor, which is a correction value used when detecting a physical quantity representing a motion state of an own vehicle based on information output by a vehicle sensor mounted to the own vehicle, the scale factor estimation device comprising:
a first physical quantity acquisition unit configured to acquire a first physical quantity calculated based on the information output by the vehicle sensor;
a second physical quantity acquisition unit configured to acquire a second physical quantity calculated based on satellite positioning information of the own vehicle;
a reliability estimation unit configured to estimate the reliability of target data including the first physical quantity and the second physical quantity; and
a scale factor calculation unit configured to accumulate data and calculate the scale factor based on the target data estimated as having a high reliability by the reliability estimation unit.

2. The scale factor estimation device according to claim 1, further comprising
a scale factor learning unit configured to accumulate calculation results of the scale factor and performs a learning process for the scale factor so that a calculation accuracy of the scale factor reaches a predetermined target accuracy.

3. The scale factor estimation device according to claim 2, wherein
the scale factor learning unit is configured to determine whether to complete the learning process based on the fluctuation state of the calculated value of the scale factor.

4. The scale factor estimation device according to claim 2, configured to select one information that has higher calculation accuracy from the learned value already obtained by completion of the learning process and a current value calculated this time by the scale factor calculation unit, as the scale factor for calculating the physical quantity.

5. The scale factor estimation device according to claim 3, configured to select one information that has higher calculation accuracy from the learned value already obtained by completion of the learning process and a current value calculated this time by the scale factor calculation unit, as the scale factor for calculating the physical quantity.

6. A scale factor estimation method for estimating a scale factor, which is a correction value used when detecting a physical quantity representing a motion state of an own vehicle based on information output by a vehicle sensor mounted to the own vehicle, the scale factor estimation method comprising:
acquiring a first physical quantity calculated based on the information output by the vehicle sensor;
acquiring a second physical quantity calculated based on satellite positioning information of the own vehicle;
estimating the reliability of target data including the first physical quantity and the second physical quantity; and
accumulating data and calculating the scale factor based on the target data estimated as having a high reliability by the reliability estimation unit.

7. A non-transitory computer-readable storage medium storing a scale factor estimation program for estimating a scale factor, which is a correction value used when detecting a physical quantity representing a motion state of an own vehicle based on information output by a vehicle sensor mounted to the own vehicle, the scale factor estimation program causing a processor to perform:
acquiring a first physical quantity calculated based on the information output by the vehicle sensor;
acquiring a second physical quantity calculated based on satellite positioning information of the own vehicle;
estimating the reliability of target data including the first physical quantity and the second physical quantity; and
accumulating data and calculating the scale factor based on the target data estimated as having a high reliability by the reliability estimation unit.
